(19) United States
(12) Patent Application Publication
(10) Pub. No.: US 2008/0016691 A1
(43) Pub. Date: Jan. 24, 2008

(54) Multi-use shaving implement

(75) Inventors: Andrew J. Pennella, Stamford, CT (US); Armin Bartschi, Winznau (CH); Franz Fischer, Triengen (CH); Philipp Pfenniger, Triengen (CH)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/701,880

(22) Filed: Feb. 2, 2007

Related U.S. Application Data
(63) Continuation-in-part of application No. 11/480,726, filed on Jul. 3, 2006.
(60) Provisional application No. 60/764,932, filed on Feb. 2, 2006.

(51) Int. Cl. B26B 19/00

(52) U.S. Cl. 30/34.1

(57) ABSTRACT

A shaving device is provided that includes a handle, a razor cartridge, and a powered trimmer. The handle includes a first end, a second end, and a grip portion. The grip portion has a motor included at least partially therein. The razor cartridge is attached to the first end of the handle. The powered trimmer head is located at the second end of the handle and is selectively activated by the user. When activated, the powered trimmer is powered by the motor in the grip portion of the handle and is operable to trim hair.

### CROSS-REFERENCE TO RELATED APPLICATIONS

This application claims the benefit of U.S. Provisional Patent Application No. 60/764,932, entitled “MULTI-USE SHAVING IMPLEMENT,” filed on Feb. 2, 2006, which is hereby incorporated herein by reference, and is a continuation-in-part of U.S. patent application Ser. No. 11/480,726 entitled “INTEGRATED WET SHAVING AND TRIMMING IMPLEMENT,” filed on Jul. 7, 2005, which is also hereby incorporated herein by reference.

### FIELD OF THE INVENTION

The present invention is generally directed to shaving implements in general, and to shaving implements employing wet shave razors having a powered long hair trimmer incorporated therein in particular.

### BACKGROUND OF THE INVENTION

Most prior art shaving implements, also commonly known as wet shave razors, include a razor cartridge and a handle. The razor cartridge typically includes at least one blade positioned aft of a guard bar and forward of a cap. During use, the razor cartridge is mounted on a handle such that it can pivot relative to the handle between a resting position and a rotated position.

The prior art razors described above are quite useful for shaving a surface short hair, or stubble, from a surface. However, they generally are not as useful for maintaining, shaping and/or trimming longer hair (e.g., mustaches, goatees, sideburns, and/or body hair). Various types of shaving devices other than wet shave razors, such as trimmers, are known to have particular utility for such uses. Trimmers typically operate through the use of two (2) adjacent blades that move relative to one another. One blade is reciprocally moved back and forth by a motor, and the other blade remains stationary. Each trimmer blade has a series of teeth that operate to cut hair in a scissoring fashion as the teeth of the moving blade move past the teeth of the stationary teeth when the motor is turned on.

Some devices have been disclosed that combine wet shave razors and trimmers. These devices typically include a trimmer that is permanently attached to the handle and movable between a use position and a non-use position. However, each of the prior art devices has inherent drawbacks. For example, some devices have the trimmer permanently positioned at the same end of the handle as the razor cartridge. In these prior art devices, the handle is often unbalanced due to the extra weight of the trimmer. In addition, many of the prior art devices have generally not made provisions for trimming hair to a desired length.

Based on the foregoing, it is therefore desirable to provide a shaving device that overcomes the problems and drawbacks associated with the prior art.

### SUMMARY OF THE INVENTION

According to one aspect of the present invention, a shaving device includes a handle, a razor cartridge, and a powered trimmer. The handle includes a first end, a second end, and a grip portion. The handle has a motor included at least partially therein. The razor cartridge is attached to the first end of the handle. The powered trimmer bead is located at the second end of the handle and is selectively activated by the user. When activated, the powered trimmer is powered by the motor in the handle and is operable to trim hair.

According to an even further aspect of the present invention, the trimmer head includes two adjacent blades, one movable blade and one stationary blade. In some embodiments, each of the blades includes a series of teeth that are operable to cut hair when the teeth of the movable blade are reciprocally moved back and forth relative to the teeth of the stationary blade.

In some embodiments, the trimmer head is movable between a first position where the trimmer is stored and a second position where the trimmer is operable. In these embodiments, the trimmer can slide linearly between the first and second positions. Alternatively, the trimmer can rotate between the first and second positions. In other embodiments, the powered trimmer is stationary relative to the handle.

According to further aspects of the present invention, the shaving device can further include a comb. The comb includes a series of ridges, which allow hair to pass therebetween during trimming. The comb is operable to allow the user to trim hair at a consistent, pre-determined length. The comb can be integral with the handle, or removable from the handle.

According to further aspects of the present invention, the shaving device can further include a protective cap. The protective cap can be integral with the handle, or removable from the handle. The advantages of the present invention will be apparent to one of skill in the art in light of at least the above Summary, the included Drawings, and the Detailed Description of the Invention.

### BRIEF DESCRIPTION OF THE DRAWINGS

FIG. 1 is an isometric view of a shaving device according to one embodiment of the present invention, wherein the shaving device includes a razor cartridge and a powered trimmer head;

FIG. 1A is an enlarged front view of the razor cartridge shown in FIG. 1;

FIG. 2 is a partial top view of a second end of the handle shown in FIG. 1, wherein the trimmer head is in a first position;

FIG. 2A is a partial top view of the second end of the handle shown in FIG. 1, wherein the trimmer head is in a second position;

FIG. 3 is a schematic sectional side view of the shaving device depicting the inner workings according to one embodiment of the present invention;

FIG. 4 is an isometric view of a shaving device according to another embodiment of the present invention, wherein the shaving device includes a razor cartridge and a powered trimmer head;

FIG. 5 is a partial top view of a second end of the handle shown in FIG. 4, wherein the trimmer head is in a first position;

FIG. 5A is a partial top view of the second end of the handle shown in FIG. 4, wherein the trimmer head is in a slightly rotated position between the first position and a second position;

FIG. 5B is a partial top view of the second end of the handle shown in FIG. 4, wherein the trimmer head is in a further rotated position between the first position and the second position;

FIG. 5C is a partial top view of the second end of the handle shown in FIG. 3, wherein the trimmer head is in the second position;

FIG. 6 is a partial isometric view of a shaving device according to another embodiment of the present invention, wherein the second end of the handle includes an integral comb and the trimmer is in the first position;

FIG. 7 is a partial isometric view of the shaving device shown in FIG. 6, wherein the trimmer is in the second position; and

FIG. 8 is a partial side view of a shaving device according to another embodiment of the present invention which includes a rotatable cap that is rotated to a stored position;

FIG. 8A is a partial side view of the shaving device shown in FIG. 8 with the rotatable cap rotated to an open position;

FIG. 9 is a partial isometric view of a shaving device according to a further embodiment of the present invention that includes a removable cap;

FIG. 10A is a partial exploded isometric view of the shaving device of FIG. 9, wherein the removable cap is removed from the second end of the handle; and

FIG. 10B is a partial exploded isometric view of the shaving device shown in FIGS. 9 and 9A, wherein the shaving device includes a removable comb that is attachable to the second end of the handle.

### DETAILED DESCRIPTION OF THE INVENTION

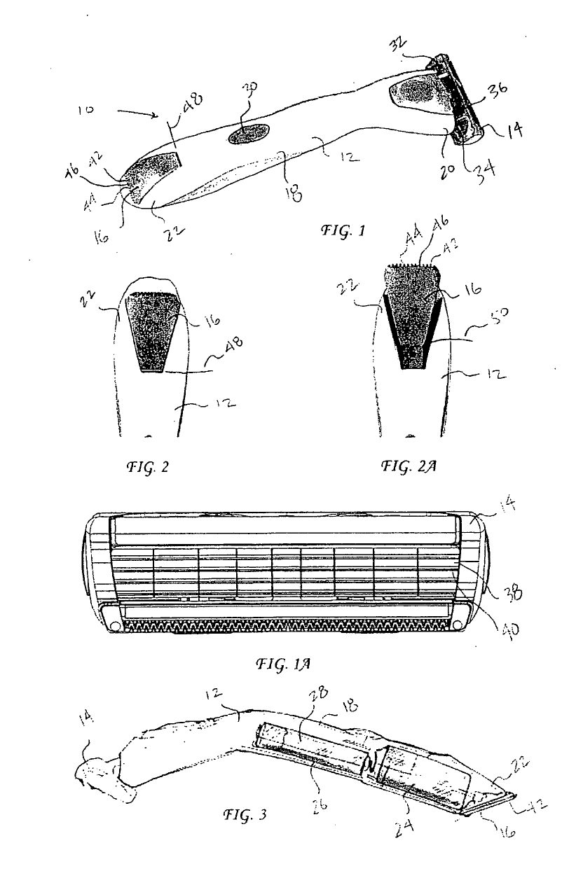

Referring to FIGS. 1-3, the shaving device 10 is shown according to one embodiment of the present invention having a handle 12, a razor cartridge 14, and a powered trimmer 16. The handle 12 includes grip portion 18, a first end 20, and a second end 22. An electrical powered motor 24 (see FIG. 3) is located at least partially within the grip portion 18 of the handle 12. The razor cartridge 14 is attached to the first end 20 of the handle 12. The powered trimmer 16, which is operatively connected to the motor 24 in the handle 12, is located at the second end 22 of the handle 12. The shaving device 10 of the present invention can, in one respect, be used as a wet shave razor when the user shaves a surface using the razor cartridge 14. In another respect, the shaving device 10 of the present invention can be used to trim hair by activating the powered trimmer 16 located at the second end 22 of the handle 12.

Referring now to FIGS. 1, 3 and 5, the grip portion 18 of the handle 12 is elongated and preferably ergonomically shaped to be easy for the user to manipulate in any one of many advantageous manners. The exact location of the razor cartridge 14 at the first end 20 of the handle 12 and the powered trimmer 16 at the opposite second end 22 of the handle 12 is preferably manipulated by the designer in order to achieve a well-balanced shaving device 10. The cartridge 14 and powered trimmer 16 are located at the respective first and second ends 20 and 22 of handle 12 if they are at or near the corresponding handle end.

Referring to FIG. 3, the motor 24 is at least partially located in the grip portion 18 of the handle 12. In one embodiment, the handle 12 also includes a chamber 26 sized to house a battery 28 used to power the electric motor 24. In these embodiments, the chamber 26 can have a cap (not shown) so that the battery 28 can be selectively replaced. Alternatively, the chamber 26 can be closed such that the handle 12 is to be replaced once the battery 28 has expired. However, the present invention should not be considered to be limited to DC battery-power. The motor 24 of the present invention can be powered by any suitable means, such as through the use of a power cord (not shown) intended to be plugged into an electrical wall outlet that supplies AC power. The motor 24 can be selectively turned on or off by a switch 30. The present invention can utilize any one of the known types of switches 30 (e.g., push button switch, toggle switch, slide switch).

The handle 12 can also include a first connector 32 located at the first end 20 of the handle 12. According to one embodiment, the first connector 32 includes a pair of arms 34 having projections, as shown in FIG. 1, that connect with a complimentary second connector 36 located on the razor cartridge 14 (discussed infra.). The second connector 36 may include a pair of slots that receive the projections of arms 34 to form a shell bearing connection, according to the exemplary embodiment. However, the first and second connectors 32 and 36 should not be considered to be limited to a shell bearing type connection, and can be of any suitable type known to those of skill in the art including, but not limited to, a single point docking connection.

Referring now to FIGS. 1 and 1A, the razor cartridge 14 includes at least one elongated blade 38 that has a sharpened cutting edge 40. In the embodiment shown, the cartridge 14 has four parallel elongated blades 38 generally located rearward of a guard 80 and forward of a cap 82. The cap 82 may include a lubricating strip. The blades 38, guard 80 and cap 82 of cartridge 14 define a primary shaving plane that generally extends below the underside of handle 12.

The razor cartridge 14 also includes the second connector 36 that enables the user to removably attach the razor cartridge 14 to the handle 12. According to one embodiment, the second connector 36 is complimentary to the first connector 32 (discussed supra.) such that the razor cartridge 14 is pivotable relative to the handle 12 when connected; however, the second connector 36 should not be considered to be so limited. Rather, the second connector 36 can be of any suitable type known to those of skill in the art. In some embodiments, it may be desirable for the razor cartridge 14 to not be pivotable relative to the handle 12. In other embodiments, it may be desirable for the razor cartridge 14 to be non-removably attached to the handle 12.

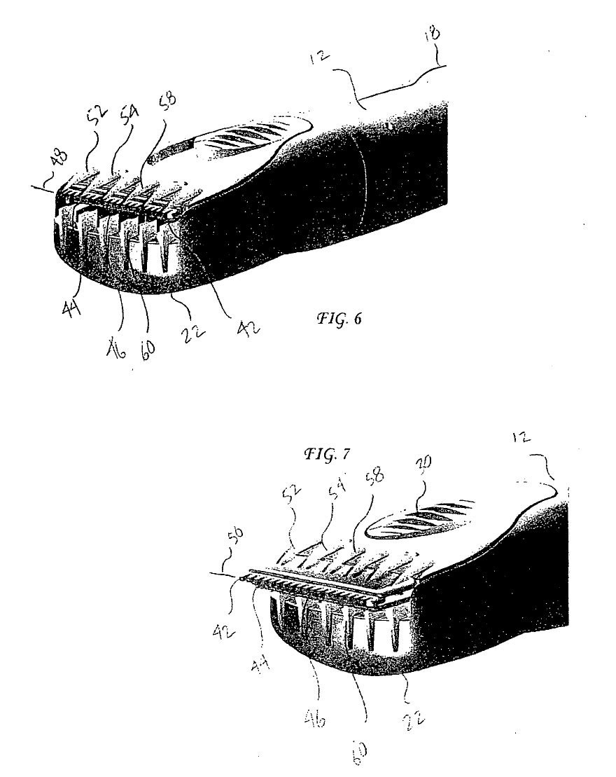

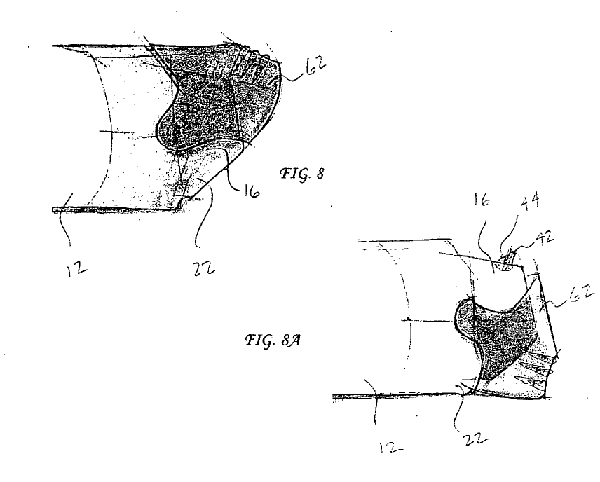

Referring now to FIGS. 2, 2A, 3, 4, 6, 8A, 10A and 10B, the powered trimmer 16 includes one stationary trimmer blade 42 and one movable blade 44 according to one embodiment. The two (2) trimmer blades 42 and 44 are positioned adjacent one another and each includes sharpened teeth 46 that are able to trim hair when the movable blade 44 is reciprocally moved back and forth relative to the stationary blade 42. The trimmer blades 42 and 44 of the powered trimmers 16 shown in the FIGS are merely exemplary. The number and size of the teeth 46 can vary greatly depending on a number of factors, including, for example, the power of the motor 24 located in the handle 12. It should be further noted that the blades of the powered trimmer 16 can be oriented at any angle relative to the grip portion 18 of the handle 12 depending on the desired orientation of the blades 42, 44 of the powered trimmer 16 during use. FIGS. 3 and 6 are merely exemplary angles for use with the particular handles 12 shown. According to another embodiment, both trimmer blades 42 and 44 may be movable. While the cartridge 14 defines a shaving plane generally extending below the underside of handle 12, the trimmer 16 has trimmer blades 42-44 at the second end of the handle 12, that are above the underside of the handle, according to the disclosed embodiments.

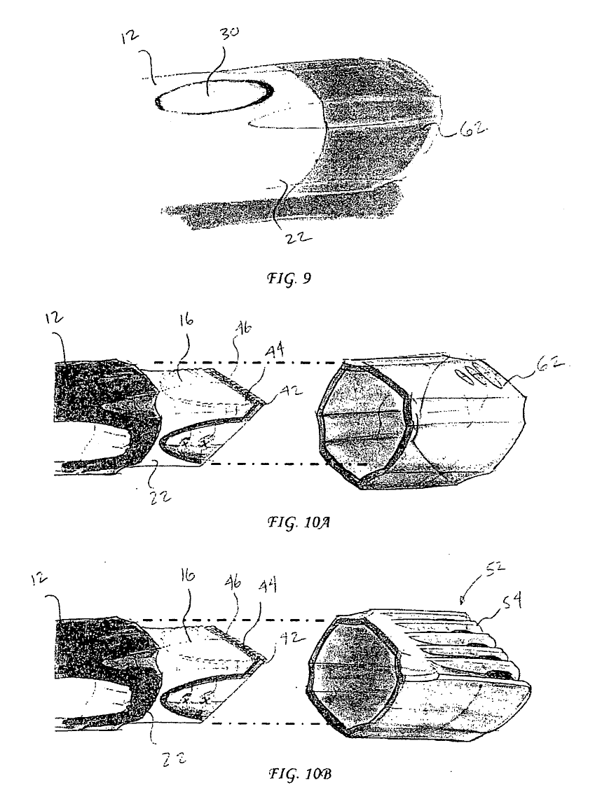

Referring now to FIGS. 3, 8, 8A, 9, 10A and 10B, the powered trimmer 16 can be fixed relative to the handle 12. In these embodiments, the powered trimmer 16 is usually powered on and off by a switch 30.

Alternatively, and now referring to FIGS. 1, 2, 2A, 4, 5, 5A, 5B, 5C, 6, and 7, the powered trimmer 16 can be movable relative to the handle 12. In these embodiments, the powered trimmer 16 can be moved between a first position 48 where the powered trimmer 16 is typically non-operable and/or stored, to a second position 50 where the powered trimmer 16 is operable. In some embodiments, such as the one shown in FIGS. 1, 2, and 2A, the powered trimmer 16 can be moved linearly along the longitudinal axis of the handle 12. In these embodiments, the powered trimmer 16 is typically substantially within the outer profile of the grip portion 18 of the handle 12 when in the first position 48. As the powered trimmer 16 moves from the first position 48 (FIGS. 1 and 2) to the second position 50 (FIG. 2A), the powered trimmer 16 moves outward from the second end 22 of handle 12 and becomes exposed and in an appropriate position for trimming hair.

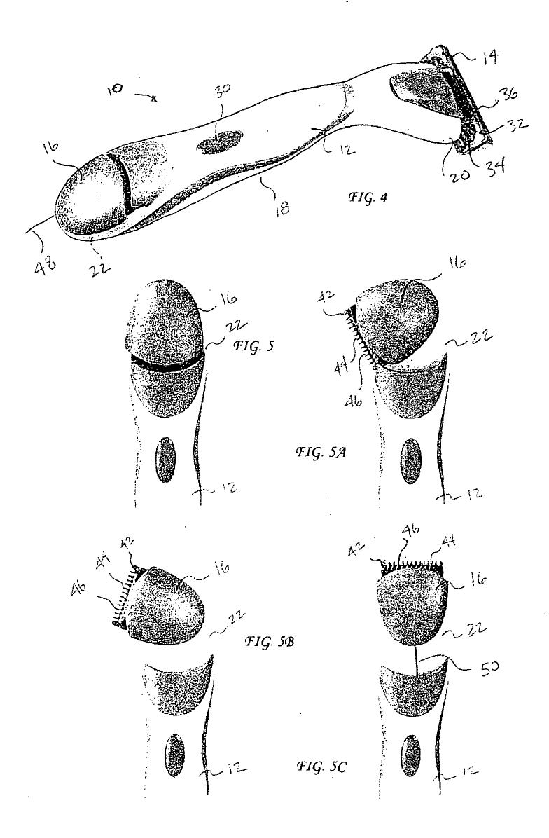

In other embodiments, such as the one embodiment shown in FIGS. 4-5C, the powered trimmer 16 is rotatable relative to the handle 10. As shown in FIGS. 4 and 5, the powered trimmer 16 is in the first position 48 where it is stored during non-use. As the powered trimmer 16 is rotated, as shown in FIGS. 5A and 5B, it is moved towards the second position 50. FIG. 5C shows the powered trimmer 16 in the second position 50, where it is in an appropriate position for trimming hair.

In even further embodiments, such as the one shown in FIGS. 6 and 7, the powered trimmer 16 is stored in the first position 48, but can be operated in any one of a number of positions between the first position 48 and second position 50. For example, in the embodiment shown in FIG. 7, a comb 52 (discussed infra.) is included. Depending on the length to which the user desires to trim the hair, the user can position the powered trimmer 16 in any one of a number of positions between the first and second positions 48 and 50.

In some embodiments of the present invention, and now referring to FIGS. 6, 7, and 10B, the shaving device 10 can further include a comb 52. The comb 52 typically includes a number of ridges 54. The ridges 54 are spaced apart to allow the hair to be trimmed to pass therebetween. However, the ridges 54 also are operable to create a gap between the teeth 46 of the powered trimmer 16 and the surface such that the hair is trimmed to a predetermined length. As shown in FIGS. 6 and 7, the comb 52 can be integral with the second end 22 of the handle 12. In these embodiments, the comb 52 typically includes a first portion 58 and a second portion 60. In these embodiments, the powered trimmer 16 is typically slidably located between the first and second portions 58, 60 of the comb 52 to provide additional protection to both the powered trimmer 16 and to the user.

In other embodiments, such as the one shown in FIG. 10B, the comb 52 can be removably attached to the handle 12. In these embodiments, the user can selectively attach a comb 52 having the desired ridges 54 over the powered trimmer 16 before trimming hair to the desired length. Alternatively, the user can remove the comb 52 entirely when it is desired to have the powered trimmer 16 directly in contact with the surface. Any suitable connectors (not shown) known in the art can be utilized in removably connecting the comb 52 to the shaving device 10.

Additionally, and now referring to FIGS. 8, 8A, 9 and 10A, the shaving device 10 can further include a cap 62. Typically, the cap 62 is intended to protect the powered trimmer 16 from damage when the powered trimmer 16 is not in use. The cap 62 can be removable. Alternatively, the cap 62 can be pivotally connected to the handle 12, as shown in FIGS. 8 and 8A, in order to prevent the loss of the cap when the powered trimmer 16 is in use.

According to a further embodiment, the shaving device 10 may further include an additional trim blade in addition to cartridge 14 and powered trimmer 16. The trim blade may be arranged on a rear surface of the cartridge and oriented generally downward and away from the primary shaving blades to enable trimming of hairs. One example of the addition of a trim blade to a cartridge is disclosed in U.S. Pat. No. 6,276,061 to Rozenkranc.

Modification and variations may be made to the disclosed embodiments without departing from the subject and spirit of the invention as defined by the following claims.

What is claimed is:

1. A shaving device, comprising:
a handle having a first end, a second end, and a grip portion;
a motor included at least partially in the handle;
a razor cartridge that is attached to the first end of the handle; and
a powered trimmer located at the second end of the handle and powered by the motor, wherein the powered trimmer is selectively activated by a user and operable to trim hair.

2. The shaving device of claim 1, wherein the motor is at least partially included in the grip portion of the handle.

3. The shaving device of claim 1, wherein the motor is powered by a battery that is located in the handle.

4. The shaving device of claim 1, wherein the powered trimmer has a first trimmer blade and a second trimmer blade, wherein the first trimmer blade is movable relative to the second trimmer blade when powered by the motor.

5. The shaving device of claim 4, wherein the first trimmer blade is a stationary blade and the second trimmer blade is a movable blade.

6. The shaving device of claim 4, wherein the powered trimmer is located at the first end of the handle such that the first and second trimmer blades extend outward from the first end of the handle along a longitudinal axis of the handle.

7. The shaving device of claim 4, wherein the trimmer blades of the powered trimmer are axially movable along a length of the handle to move from a stowed position to a deployed position.

8. The shaving device of claim 1, wherein the power trimmer is rotatable to move between a stowed position and a deployed position.

9. The shaving device of claim 1 further comprising a comb located at the second end of the handle.

10. The shaving device of claim 9, wherein the comb and power trimmer are operable to allow a user to trim hair at a predetermined length.

11. The shaving device of claim 1 further comprising a cap disposed at the second end of the handle to cover the power trimmer.

12. The shaving device of claim 1, wherein the cap pivots between an open position and a closed position.

13. The shaving device of claim 1, wherein the razor cartridge comprises at least one elongated blade, a guard, and a cap.

14. The shaving device of claim 1, wherein the handle is an elongated handle.

15. The shaving device of claim 1, wherein the cartridge defines a shaving plane extending below an underside of the handle, and the powered trimmer is located above the underside of the handle.

16. A shaving device, comprising:
a handle having a first end, a second end, and a grip portion, the grip portion having a motor included at least partially therein;
a razor cartridge that is attached to the first end of the handle; and
a powered trimmer is located at the second end of the handle, the powered trimmer is selectively activated by a user and operable to trim hair;
wherein the powered trimmer is powered by the motor at least partially in the grip portion of the handle.
